(19) United States
(12) Patent Application Publication
(10) Pub. No.: US 2002/0047261 A1
(43) Pub. Date: Apr. 25, 2002

(54) REVISABLE PERMANENT LABEL SYSTEM FOR DATA STORAGE MEDIA

(76) Inventor: STEVE G. CATES, ABILENE, TX (US)

Correspondence Address: ERIC K. SATERMO, REGISTERED PATEN AGENT, P.O. BOX 19099, IRVINE, CA, 92623-9099, US

(21) Appl. No.: 08/006,717

(22) Filed: Apr. 21, 1992

Related U.S. Application Data
(63) Continuation of application No. 07/349,215, filed on May 8, 1989, now abandoned.

(51) Int. Cl. B42D 15/00

(52) U.S. Cl. 283/81; 283/102

(57) ABSTRACT

An erasable label kit includes laminated labels with printed base laminates with adhesive coatings held on release sheets and clear thin polyester film laminates covering the printed faces. Color coded symbols are placed partially over the outer face of the polyester film. Permanent ink indicia are written on the polyester film with soft tip permanent ink pens. Erasing materials in the kit include an alcohol solvent and absorbent cleaning patches, and a draftsman's vinyl ink eraser. As information on the floppy disk changes, information on the label is changed by removing all, large parts and small parts, of the information with the erasing materials and adding the new information with the soft tip permanent ink markers.

### BACKGROUND OF THE INVENTION

This invention which concerns changeable labels for mounting on computer memory disks and other magnetic data and signal storage media is based on Disclosure Document 195576 filed Jun. 23, 1988.

The information files and programs stored on computer floppy disks and other magnetic media changes so often that relabelling over and over again is an inconvenience for users. The label becomes unsightly when information is crossed out and changed, and the entire disk becomes a mess when layers of labels are added one on top of each other. A common solution is to remove as much of the old labels as possible, and then to scrape or wipe the adhesive residue off so that a fresh label can be added.

The present invention provides a solution to that problem.

### SUMMARY OF THE INVENTION

The changeable and erasable labels of the present invention are a vast improvement over the pre-existing procedure. Only one label is applied for the life of the disk, and written information is clearly marked on the label and may be erased and replaced over and over again on the same one label.

The invention in a preferred form includes a kit with a label sized to fit the magnetic media in use, for example large floppy disks or 3.5 inch floppy computer disks. The labels are flexible laminated polyester film labels that can be marked with non-water-soluble, permanent ink, soft felt tip pens, then easily erased using a solvent and cleaning patches and a vinyl ink eraser.

The present invention allows the easy revision of labels without crossing out existing words or peeling off old labels. The present labels can be written on and erased over and over again. The present invention also provides a simple color coding technique for filing and retrieving disks and files. Particular organizational categories are preprinted under the lamination on the labels. The present invention is handier than computer printed labels because corrections are made on the spot. There is s no printer or software load and unload. Neat, clean, on-the-spot revisions are provided by the present invention, which is an easier way to manage and organize floppy disks.

The kit of the present invention provides erasable labels with all necessary erasing materials. Spot revisions or total erasures are made without tugging, ripping or tearing labels.

Each kit includes durable, erasable labels with laminations protecting underlying printed indicia, filing categories and guidelines during the adding and erasing of new material.

Removable color coded stickers are provided which are used to code disks by business category, activity status, department and other information.

Each kit contains a bottle of erasing fluid, which is a liquid, organic solvent, preferably alcohol for rapid removal of permanent ink on the outer laminate. A bag of cotton wipes which hold the solvent and lift the removed ink is included. The erasing materials also include a draftsman's-type eraser pen with a white vinyl eraser used for making small revisions to the label.

Provided in each kit is a non-smear fine point label pen which smoothly writes on the glossy label surface and dries in seconds. The ink is permanent until erased.

The invention provides an erasable label kit which includes laminated labels with printed base laminates having adhesive coatings held on release sheets and clear thin polyester film laminates covering the printed faces. Color coded symbols are placed partially over the outer face of the polyester film. Permanent ink indicia are written on the polyester film with soft tip permanent ink pens. Erasing materials in the kit include an alcohol solvent and absorbent cleaning patches, and a vinyl draftsman's ink eraser. As information on the floppy disk changes, information on the label is changed by removing all, large parts and small parts, of the information with the erasing materials and adding the new information with the soft tip permanent ink markers.

This invention provides preferably labelling apparatus for magnetic storage media. Label bases have print on one side and adhesive on an opposite side. Label covers are affixed to the printed side of the label bases. The label covers have spaces for writing in permanent ink. Soft tip pens are provided for writing on the label covers with permanent ink. Erasing materials are included for erasing permanent ink from the label covers.

In one preferred embodiment, the erasing material is a solvent for dissolving the permanent ink. Cleaning patches apply the solvent to the label covers for erasing the permanent ink. The preferred cleaning patches are absorbent material, preferably cotton. Preferably the solvent is alcohol. In one preferred embodiment, the material is a non-smudging eraser. Preferably the eraser is a vinyl eraser.

The preferred label covers are polyester films.

Preferably the covers are thin Mylar films. Thus, the label as covers are thin Mylar films which are adhered to the printed face of the base after printing.

In a preferred kit embodiment, the label base laminates are thin polyester films having printed faces and adhesive on opposite faces. The cover laminates are clear, thin polyester films adhered to the printed faces of the bases after printing. The erasing materials are a small flask of alcohol, a package of absorbent cleaning patches for use with the alcohol and a vinyl eraser pen. The permanent ink markers are permanent ink soft tip pens. The preferred kits further include plural colored symbols, and the labels have edge areas for partially receiving the colored symbols.

The invention provides an erasable label kit for magnetic storage media such as floppy disks, comprising a container and a package of lamellar labels. Each label has a base laminate having first and second faces, print on the first face, and adhesive on the second face. A release sheet is attached to the adhesive on the second face. A clear laminate is attached to the first face, the clear laminate having a print face adhered to the first face and having an outer face. A permanent ink marker applies permanent ink marks to the outer face. Erasing material lifts unwanted permanent ink marks from the outer face. Preferably the clear laminate is a thin polyester film, and the outer surface is glassy and non-porous. The preferred thin polyester film laminate is thin Mylar film. The preferred permanent ink marker is a fine point soft felt or nylon tip permanent ink marker pen. The preferred erasing material is a draftman's vinyl ink eraser. Preferably the erasing material includes an organic fast-drying solvent and solvent-absorbing cleaning patches.

These and other and further objects and features of the invention are apparent in the disclosure, which includes the above and ongoing specification, with the claims, and the drawings.

### BRIEF DESCRIPTION OF THE DRAWINGS

FIG. 1 is a schematic representation of a preferred kit of the present invention.

FIG. 2 is a detail of a label of the present invention.

FIG. 3 is a detail of another kit of the present invention.

FIGS. 4 and 5 show use of the present invention.

FIG. 6 is a detail of the kit shown in FIG. 5 +L.

### DETAILED DESCRIPTION OF THE DRAWINGS

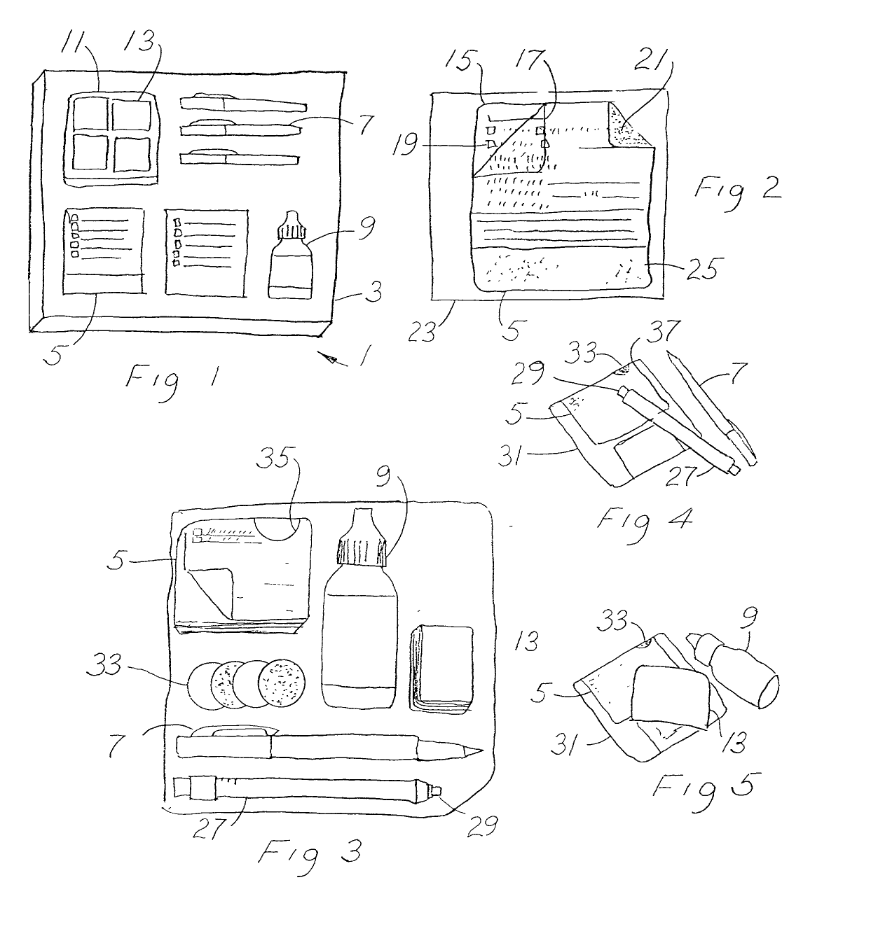

Referring to the drawings, an erasable label kit is generally indicated by the numeral 1. The kit comprises a case 3 having receptacles for holding two stacks of labels 5, permanent ink soft tip pens 7 and erasing materials, which include a small flask of alcohol 9 and a package 11 of absorbent cleaning patches 13. As shown in FIG. 2 +L, the label 5 has two laminates 15 and 17. The bottom laminate 15 has printing 19 on its front face and adhesive 21 on its rear face. The bottom laminate may be about 2 mils in thickness, the top laminate 1 mil. A release sheet 23 is attached to the rear face with the adhesive 21. After the label base laminate 15 is printed 19, the clear Mylar film 17 is added to the base laminate 15. FIG. 2 shows a colored area 25, which may be printed on the base laminate 15 to provide further information in color coded form about the label and the disk to which the label will be attached.

FIG. 3 shows an alternate form of the kit. A package of labels 5 and soft tip permanent ink marking pen 7 are included in the package. Erasing materials include a flask of solvent 9 and absorbent patches 13, and a pen-type eraser 27 with an extensible tip 29 of a vinyl tube.

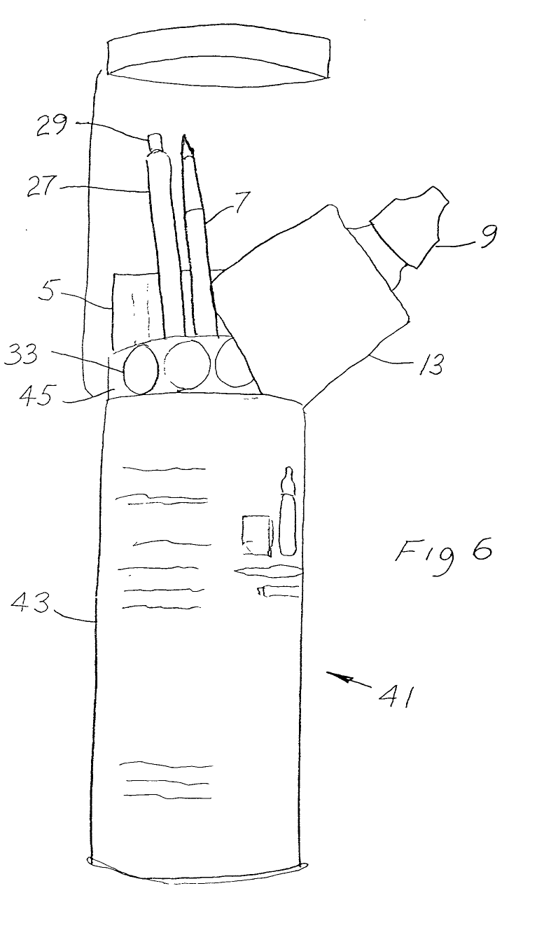

As shown in FIG. 4 +L, label 5 is placed on a data storage magnetic medium such as a 3.5 inch floppy disk 31. A color coded dot 33 is placed partially on the label in semicircle 35 on the label, and is adhered around the edge 37 of the floppy disk 31 so that the coded color information of the disk may be readily ascertained when the disk is stored in alignment with other disks. As shown in FIG. 4 +L, the disk has been marked with permanent marker 7. Small parts of information on the label are being erased with the pen-type eraser 27. As shown in FIG. 5 +L, large amounts of information on label 5 are erased using solvent from flask 9 and an absorbent cleaning patch 13.

As shown in FIG. 6 +L, a kit 41 includes the material of FIG. 3 packaged within a tubular container 43. Colored adhesive symbol dots 33 are packaged on a release sheet 45. A package of labels 5 is included in the container, as are marker pen 7, eraser 27 with vinyl tip 29, alcohol flask 9 and absorbent cleaning patches 13 for use with the alcohol. Directions for using the kit are printed on the kit.

While the invention has been described with reference to specific embodiments, modifications and variations of the invention may be constructed without departing from the scope of the invention. For example, the invention may use labels made of clear polyester sheets which are printed with mirror image reversed words on the opposite sides and coated with an opaque pressure sensitive adhesive. The labels 5 which are so constructed may be packaged one label on the top of another label, with the print appearing through the clear polyester film laminate and the outer face being ready to receive permanent ink from pen 7. A label so constructed could be peeled from the top of a stack of labels and pressed onto the surface of the floppy disk, whereupon the writing could be placed on a clear face with the marker pen 7. The reversed printed material shows through the label, while the opaque adhesive makes the underlying permanent print easy to read. While the invention is preferably made with laminated Mylar polyester films, the lower of which is printed and the top of which is clear, the underlying film may be made of any material, for example fabric or paper. Mylar is preferred because of the absence of abraded particulate castoff material which may interfere with the computer operations.

In the simplest form, the material is provided in a bubble package as shown in FIG. 1 +L. A canister as shown in FIG. 6 is useful. The materials may be packaged in a conventional package used for floppy disks so that the revisable permanent labelling system of the present invention may be stored in a convenient manner. Other modifications of the invention may be made without departing from the scope of the invention.

I claim:

1. Revisable permanent label system for data storage media, comprising label bases having printing on first sides and adhesive on second opposite sides, label covers affixed to the printed sides of the label basis, the label covers having spaces for writing, permanent ink felt tip pens for writing on the label covers, and erasing materials for erasing permanent ink from the label covers.

2. The apparatus of claim 1, wherein the erasing material comprises a solvent for dissolving the permanent ink and cleaning patches for applying the solvent to the label covers for erasing the permanent ink.

3. The apparatus of claim 2, wherein the cleaning patches are absorbent material.

4. The apparatus of claim 2, wherein the solvent is alcohol.

5. The apparatus of claim 1, wherein the erasing material is a non-smudging eraser.

6. The apparatus of claim 5, wherein the eraser is a vinyl ink eraser.

7. The apparatus of claim 1, wherein the covers are an polyester film.

8. The apparatus of claim 7, wherein the covers are thin polyester films.

9. The apparatus of claim 1, wherein the label covers are thin Mylar films which are adhered to the printed face of the base after printing.

10. The apparatus of claim 1, wherein the label bases are thin polyester films having printed faces and adhesive on an opposite faces, wherein the covers are clear polyester films adhered to the printed faces of the bases after printing, and wherein the erasing materials are a small flask of alcohol, a package of absorbent cleaning patches for use with the alcohol and a vinyl eraser pen, and wherein the permanent ink markers are permanent ink felt tip pens.

11. The apparatus of claim 10, further comprising plural colored symbols, and wherein the labels have edged areas for partially receiving the colored symbols.

12. An erasable label kit for computer floppy disks, comprising a container, a package of lamellar labels, each label having a base laminate having first and second faces, print on the first face, and adhesive on the second face, a release sheet attached to the adhesive on the second face, a clear laminate attached to the first face, the clear laminate having a print face adhered to the first face and having an outer face, a permanent ink marker for applying permanent ink marks to the outer face and erasing material for lifting permanent ink marks from the outer face.

13. The apparatus of claim 1, wherein the clear laminate is an polyester thin film and wherein the outer surface is non-porous and glassy.

14. The apparatus of claim 12, wherein the polyester thin film laminate is Mylar thin film.

15. The apparatus of claim 11, wherein the permanent ink marker is a fine point soft tip permanent ink marker pen.

16. The apparatus of claim 11, wherein the erasing material is a draftsman's vinyl ink eraser.

17. The apparatus of claim 14, wherein the erasing material further comprises an organic fast-drying solvent and cleaning patches.
